(19) United States
(12) Patent Application Publication
(10) Pub. No.: US 2011/0007128 A1
(43) Pub. Date: Jan. 13, 2011

(54) TELECONFERENCE DEVICE COMBINING A CAMERA LENS

(76) Inventor: YEN-TSO CHEN, Taipei (TW)

Correspondence Address: LEONG C. LEI, PMB # 1008, 1839 YGNACIO VALLEY ROAD, WALNUT CREEK, CA, 94598, US

(21) Appl. No.: 12/822,197

(22) Filed: Jun. 24, 2010

(30) Foreign Application Priority Data
Jul. 10, 2009 (TW) 098212569

(51) Int. Cl. H04N 7/14; H04N 7/26

(52) U.S. Cl. 348/14.08; 348/14.13; 348/E07.083

(57) ABSTRACT

A video capturing device includes a USB transmission interface interconnected with a computer to transmit information and a data processing device primarily formed by an H.264 coding module and an audio coding module. Through the H.264 coding module, the audio coding module and a real-time coding-decoding module in the computer, digital video information, an audio signal, a dynamic data and a static data are received respectively. These data are encoded, compressed, and then transmitted through the USB transmission interface to the computer and then to a remote server. When the compressed information from the remote server is received by the computer, the information is decoded by an H.264 decoding module and an audio decoding module in the computer or the data processing device and then transmitted to an external device. By this external data processing device, the present invention can be carried conveniently and applied to any kinds of computers.

### BACKGROUND OF TITLE INVENTION

a) Field of the Invention

The present invention relates to a teleconference device and more particularly to a teleconference device combining a camera lens which applies an H.264 coding module built in the camera lens to conduct video coding and decoding.

b) Description of the Prior Art

As continuous development of technologies, a modem person can communicate everywhere through internet. From communication by letters to transmission of voice and to existing video communication, it shows the convenience that the technologies have brought. The video communication can not only be applied to chatting among ordinary clients but also be used in a multi-personal meeting at a remote distance. Moreover, the video communication is even provided with good practicability to social security and medical behaviors.

The conventional video communication should rely on a coding module built in a computer to transmit audio and video packets to a receiving end. However, as rapid development of a laptop computer, the laptop computer is getting smaller and smaller; whereas, part of the audio and video functions must be sacrificed relatively. Taking an Eee PC as an example, many business persons will choose the small Eee PC to deal with businesses as the Eee PC is more convenient when taking a business trip. As the business persons may have a long business trip, a long distance meeting will be rather frequent. Nevertheless, as there is no H.264 coding module in an Eee PC, it will cause a trouble to the business persons in this respect.

Accordingly, how to solve the aforementioned issues and shortcomings of the prior art is a direction of research and development for improvement by the present inventor and related vendors.

### SUMMARY OF THE INVENTION

The primary object of the present invention is to provide a video capturing device which is provided with a USB (Universal Serial Bus) transmission interface interconnected with a computer to transmit information. An interior of the video capturing device is also provided with a data processing device which is primarily constituted by an H.264 coding module and an audio coding module, wherein the H.264 coding module, the audio coding module and a real-time coding-decoding module in the computer receive respectively digital video data, an audio data and a related dynamic and static data of the computer. These data are coded, compressed and computed and then transmitted through the USB transmission interface to the computer and then to a remote server. Therefore, by this external data processing device, the present invention can be carried conveniently and can be applied to all kinds of computers.

Another object of the present invention is to provide a teleconference device combing a camera lens, wherein by an H.264 decoding module and an audio decoding module in a computer or a data processing device, related compressed information of a remote server can be received, decoded and then transmitted to an external device.

Still another object of the present invention is to provide a teleconference device combining a camera lens, wherein as data coding and decoding can be performed directly through the video capturing device, an entire structure is simple that a total price can be inexpensive.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of using a preferred embodiment of the present invention.

FIG. 2 shows a flow diagram of H.264 coding of the preferred embodiment of the present invention.

FIG. 3 shows a flow diagram of audio coding of the preferred embodiment of the present invention.

FIG. 4 shows a flow diagram of video decoding and audio decoding of the preferred embodiment of the present invention.

FIG. 5 shows a block diagram of a data processing device of another embodiment of the present invention.

### DETAILED DESCRIPTION OF THE PREFERRED EMBODIMENTS

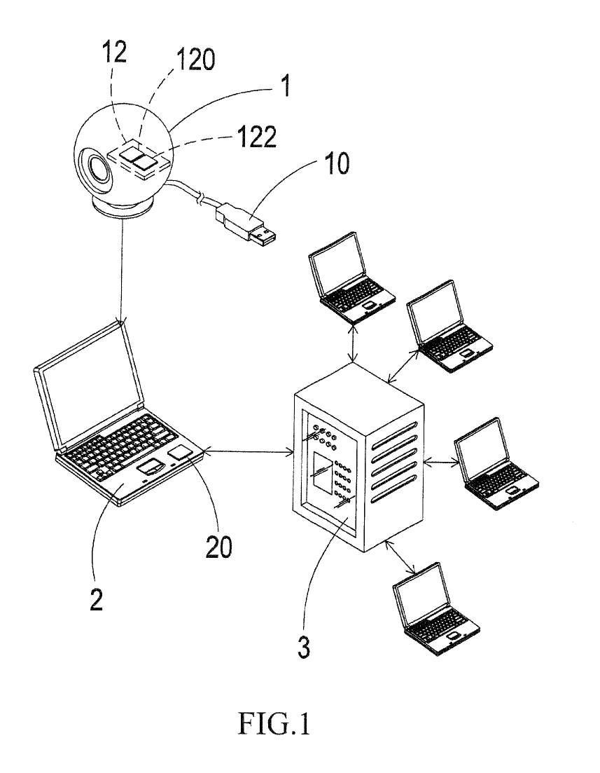

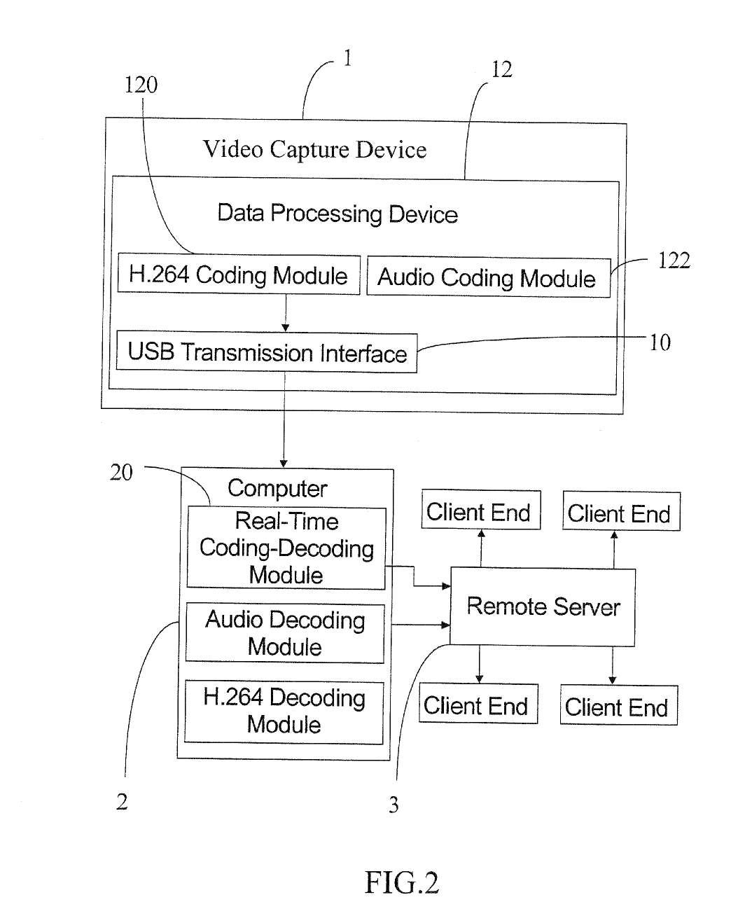

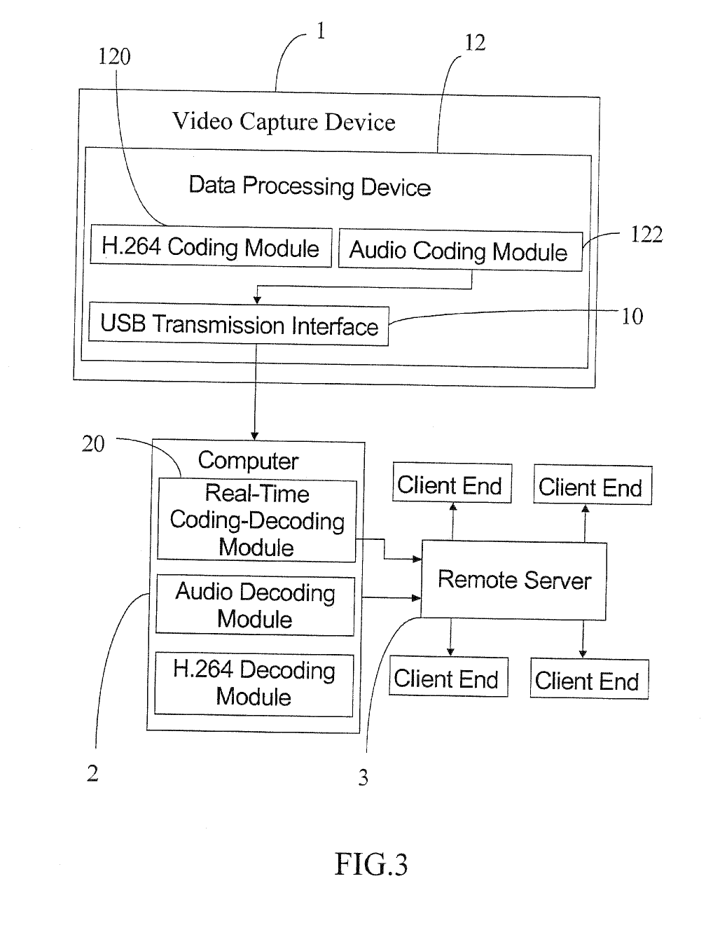

Referring to FIGS. 1 to 3, it shows a schematic view of using a preferred embodiment of the present invention, a flow diagram of H.264 coding of the preferred embodiment of the present invention and a flow diagram of audio coding of the preferred embodiment of the present invention. As shown in the drawings, the present invention is a video capturing device 1 which is provided with a USB transmission interface 10 interconnected with a computer 2 to transmit information. An interior of the video capturing device 1 is provided with a data processing device 12 which is primarily composed of an H.264 coding module 120 and an audio coding module 122, wherein through the 11.264 coding module 120, a digital video signal (which is converted from an analog video signal by a video analog-to-digital conversion module (not shown in the drawings)) can be received, coded, compressed and computed, followed by being transmitted to the computer 2 through the USB transmission interface 10. The compressed information is then transmitted to at least a remote server 3 through the computer 2, so as to facilitate other client end to download the coded and compressed information through other computer 2.

In addition, the audio coding module 122 can also simultaneously receive an analog audio signal which is transmitted from an external audio device and received by an audio analog-to-digital conversion module (not shown in the drawings). Through the audio analog-to-digital conversion module, the analog audio signal is converted into a digital audio signal which is then coded by the audio coding module 122, followed by being transmitted through the USB transmission interface 10. Accordingly, the audio signal can be processed at a same time, so as to achieve an object of having a conference.

On the other hand, through a real-time coding-decoding module 20 in the computer 2, a related dynamic or static data in the computer 2 can be coded, compressed and transmitted to the computer 2 at other client end, allowing the remote client to access the compressed information through the computer 2 and to display the data simultaneously after the information has been decoded, thereby facilitating the conference.

By the aforementioned external data processing device and through the interior H.264 coding module 120 and the audio coding module 122 thereof, the present invention can be applied to any kinds of computers without the coding devices.

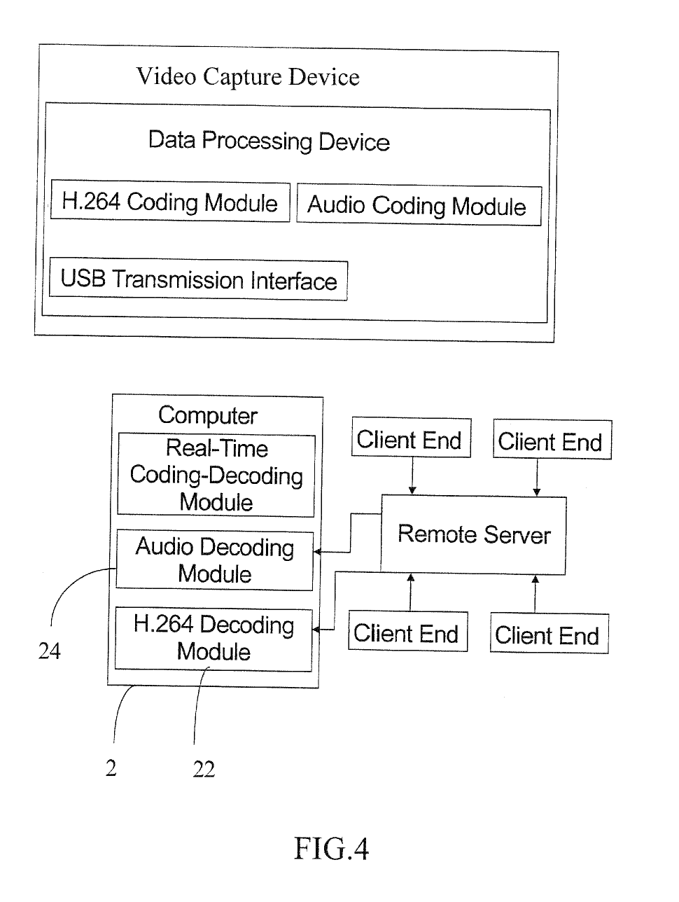

Referring to FIG. 4, it shows a flow diagram of video decoding and audio decoding of the preferred embodiment of the present invention. As shown in the drawing, an interior of the computer 2 is provided with an H.264 decoding module 22 and an audio decoding module 24. When other client end uploads coded data of related video and audio to the remote server 3, the coded data of video and audio can be downloaded to the H.264 decoding module 22 and the audio decoding module 24 respectively, and can be computed and decoded at a same time. Next, through an external display device and an audio playing device, users can conduct the conference.

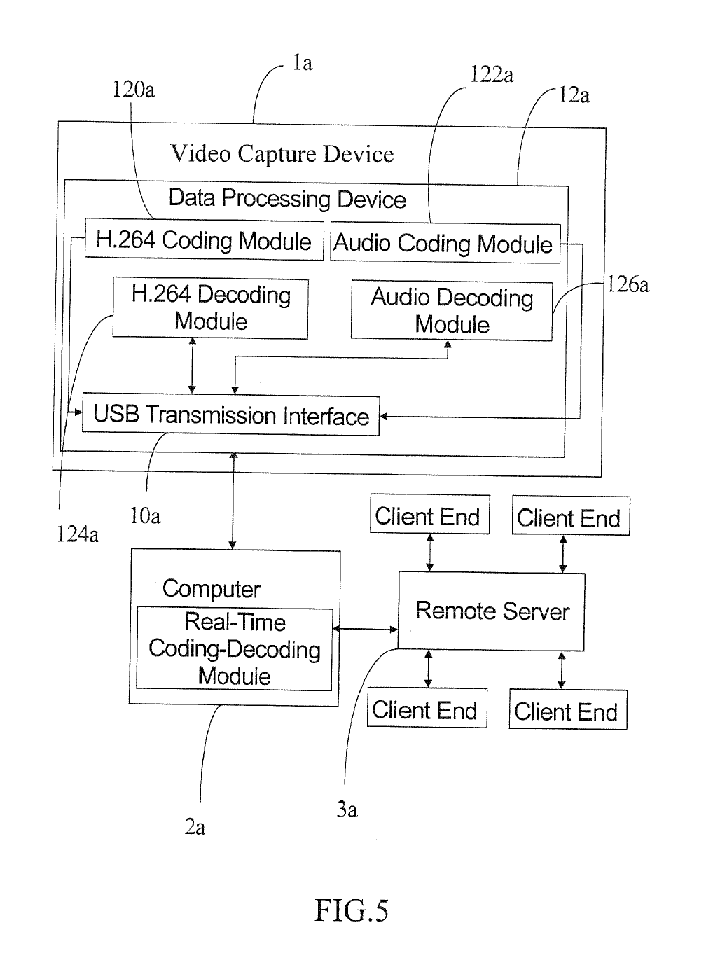

Referring to FIG. 5, it shows a block diagram of a data processing device of another embodiment of the present invention. As shown in the drawing, to increase the decoding function of a data processing device 12a in a video capturing device 1a, in addition to being provided with an H.264 coding module 120a and an audio coding module 122a, the data processing device 12a is also provided with an H.264 decoding module 124a and an audio decoding module 126a. After a remote server 3a has accessed compressed video and audio information from a computer 2a at other client end, the information can be transmitted to the H.264 decoding module 124a and the audio decoding module 126a in the data processing device 12a through a USB transmission interface 10a and is then decompressed. At this time, the video and audio data are transmitted back to the computer 2a through the USB transmission interface 10a and played through an external display device or a speaker, allowing the users to conduct the conference successfully; whereas, the audio data can be also played through a loud-speaker (not shown in the drawing) provided in the data processing device itself.

Accordingly, by the aforementioned external connection method, the video capturing device 1a can be freely applied to the computer 2a without support of the H.264 coding module 120a to effectively process the video information. In addition, through the remote server 3a, the same packet information can be downloaded by the client who participates in the teleconference through the computer 2a. Not only the entire video capturing device 1a is provided with a simple structure that the entire device is relatively smaller to reduce a manufacturing cost and a sale price, but also the packets after coding can have a smaller transmission unit through the H.264 coding module 120a.

It is of course to be understood that the embodiments described herein is merely illustrative of the principles of the invention and that a wide variety of modifications thereto may be effected by persons skilled in the art without departing from the spirit and scope of the invention as set forth in the following claims.

I claim:

1. A teleconference device combining a camera lens comprising:
a video capturing device which is provided with a USB transmission interface interconnected with a computer to transmit information;
at least a data processing device which is provided in the video capturing device and includes an H.264 coding module to receive, encode, compress and compute digital video information, with the compressed digital information being transmitted through the USB transmission interface to the computer and then to a remote server and an audio coding module to receive, encode, compress and compute an audio signal, with the compressed audio signal being transmitted through the USB transmission interface to the computer and then to the remote server.

2. The teleconference device combining a camera lens according to claim 1, wherein the computer further includes an H.264 decoding module which receives compressed information from the remote server to decompress and compute, with the compressed information being accessed by the remote server from a computer at other client end.

3. The teleconference device combining a camera lens according to claim 1, wherein the computer further includes an audio decoding module which receives compressed information from the remote server to decompress and compute, with the compressed information being accessed by the remote server from a computer at other client end.

4. The teleconference device combining a camera lens according to claim 1, wherein the computer further includes a real-time coding-decoding module for transmitting computer-related information to the remote server.

5. The teleconference device combining a camera lens according to claim 1, wherein the H.264 coding module is a real-time coding module.

6. A teleconference device combining a camera lens comprising:
a video capturing device which is provided with a USB transmission interface interconnected with a computer to transmit information; and
at least a data processing device which is provided in the video capturing device and includes an H.264 coding module to receive, encode, compress digital video information, with the compressed digital video information being transmitted through the USB transmission interface to the computer and then to a remote server; an audio coding module to receive, encode, compress an audio signal, with the compressed audio signal being transmitted through the USB transmission interface to the computer and then to a remote server; an H.264 decoding module to receive, decode and decompress compressed video information transmitted by the remote server; and an audio decoding module to receive, decompress and compute compressed audio information transmitted by the remote server.

7. The teleconference device combining a camera lens according to claim 6, wherein the computer further includes a real-time coding-decoding module for transmitting computer-related information to the remote server.

8. The teleconference device combining a camera lens according to claim 6, wherein the H.264 coding module is a real-time coding module.
